(19) United States
(12) Patent Application Publication
(10) Pub. No.: US 2013/0003208 A1
(43) Pub. Date: Jan. 3, 2013

(54) Bird Collision Avoidance Treatment for Exterior Glass

(76) Inventors: Robert Alsip, Oakville (CA); George Turjanica, Etobicoke (CA); Vahid Seyfaie, Mississauga (CA); Ian Clements, Barrie (CA)

(21) Appl. No.: 13/171,714

(22) Filed: Jun. 29, 2011

(51) Int. Cl. G02B 5/00; B44C 1/17

(52) U.S. Cl. 359/893; 156/230

(57) ABSTRACT

There is disclosed a glass treatment for treating exterior glass to prevent bird collisions with the glass. The treatment consists of a plurality of visible markings applied to an exterior surface of the glass, the plurality of markings extending substantially across the entire exterior surface. The markings are separated from each other by a vertical distance not exceeding 2.5 inches and by a horizontal distance not exceeding 4.5 inches. The markings occupy no more than 15% of the exterior surface of the glass.

### FIELD OF THE INVENTION

The invention relates generally to glass having features designed to prevent bird collisions.

### BACKGROUND OF THE INVENTION

Exterior glass exists in all buildings and homes. Clear, tinted or reflective glass on the exterior of buildings and homes is not ‘seen’ by birds and therefore collisions with exterior glass are frequent and usually fatal. If the glass is optically clear, birds try to fly through the opening and, if reflective, they fly towards the reflected sky or foliage. Making the exterior glass as visible as possible to birds will significantly decrease the likelihood of collisions. Applying images (stickers) of a bird predator to the exterior surface of the glass makes the glass more visible; however, these glass treatments also make the glass less appealing to people. Also, applying stickers to a glass is not very effective in deterring bird collisions with the glass as birds simply try to fly “around” what they think is an obstruction. Other treatments that are applied to the inner surface of exterior glass are ineffective in preventing bird collisions since the exterior surface of transparent, tinted or reflective glazed glass is reflective. Therefore, these treatments are often not visible to birds. What is required is an effective and inexpensive way of treating glass to effectively prevent bird collisions with the treated glass.

### SUMMARY OF THE INVENTION

In accordance with one aspect of the present invention, there is provided a treatment for exterior glass to prevent bird collisions with the glass. The treatment consists of a plurality of visible markings applied to an exterior surface of the glass. The markings are separated from each other by a vertical distance not exceeding 2.5 inches and by a horizontal distance not exceeding 4.5 inches. The markings take up an area of no more than about 15% of the exterior surface.

In accordance with another aspect of the present invention, there is provided a method of applying the treatment of preventing bird collisions with exterior glass as defined in the previous paragraph. The method includes the steps of providing an elongated flexible strip having a row of equally spaced stickers formed on a first side thereof. The stickers each have a first side loosely adhered to the first side of the flexible strip and a second side having an adhesive configured to securely adhere the sticker to the exterior surface of the glass. The stickers on the flexible strip are each separated by a first distance. A first portion of the flexible strip is then laid across the exterior surface of the glass in a first line, the first side of said first portion of flexible strip being pressed against the exterior surface of the glass as the first line is laid with sufficient force to cause the stickers on the first portion of the flexible strip to adhere to the glass. The first portion of the flexible strip is then removed from the surface of the glass to leave a first line of markings adhered to the exterior surface of the glass. A second portion of the flexible strip is then laid across the exterior surface of the glass in a second line adjacent to and parallel with the first line of markings. The second line is spaced from the first line by a second distance. The first side of said second portion of flexible strip is pressed against the exterior surface of the glass with sufficient force to cause the stickers on the second portion of the flexible strip to adhere to the glass. The second portion of the flexible strip is then removed from the surface of the glass to leave a second line of markings adhered to the exterior surface of the glass. These steps are repeated over and over until substantially the entire external surface of the glass is covered with stickers. The first and second distances are selected such that the markings which are placed on the exterior surface of the glass are separated by the vertical distance of no more than 2.5 inches and by the horizontal distance of no more than 4.5 inches.

In accordance with another aspect of the present invention, there is provided a treatment for exterior glass to prevent bird collisions with exterior glass. The treatment consists of a plurality of markings visible to birds applied to a surface of a thin durable flexible plastic sheet. The markings are separated from each other by a vertical distance not exceeding 2.5 inches and by a horizontal distance not exceeding 4.5 inches. The plastic sheet is adhered to the exterior surface of the glass. The markings on the plastic sheet take up an area of no more than about 15% of the exterior surface.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a front view of a prior art anti-bird collision glass treatment.

FIG. 2 is a front view of glass having an anti-bird collision glass treatment made in accordance with the present invention applied thereto.

FIG. 3 is a front view of glass receiving an anti-bird collision glass treatment made in accordance with the present invention.

FIG. 4 is a front view of a flexible backing strip forming part of the anti-bird collision glass treatment made in accordance with the present invention.

FIG. 5 is a roll of backing strip shown in FIG. 4.

In the drawings like characters of reference indicate corresponding parts in the different figures.

### DETAILED DESCRIPTION OF THE INVENTION

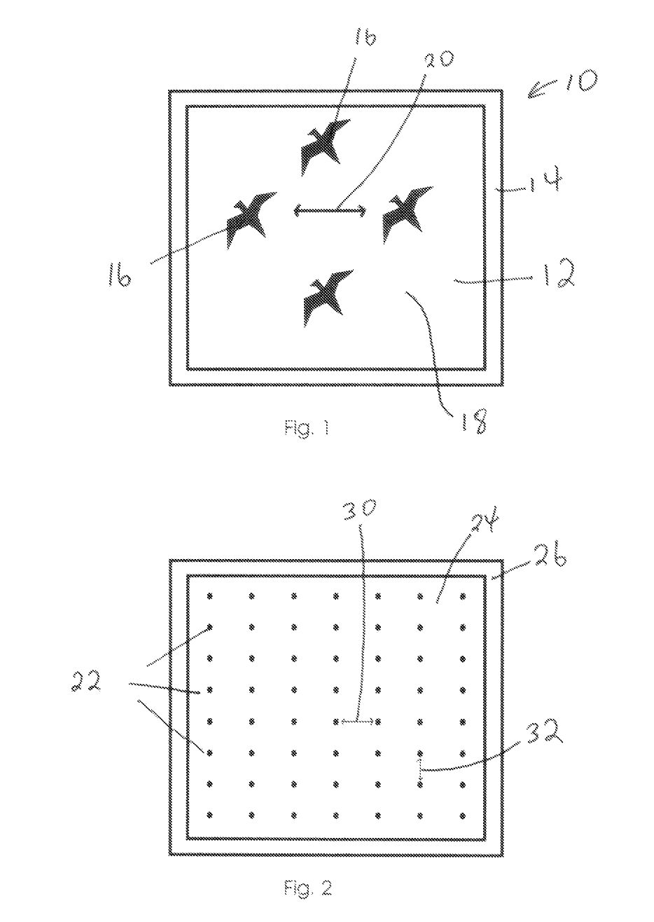

Referring to FIG. 1, prior art glass treatments, which were intended to deter bird collisions often included a plurality of visible markings applied to an inside surface of a window or exterior glass. Stickers which have been applied to the exterior surface of glass in order to deter bird collisions often took the form of silhouettes of predatory birds such as falcons and the like. It was believed that such silhouettes discouraged bird collisions by scaring away the birds. FIG. 1 illustrates one such window treatment designed to avoid bird collisions. Pane 10 consists of exterior glass 12 contained in a frame 12. Glass pane 12 has an exterior surface which faces the outside environment and an inside surface which faces the building interior. A prior art anti-bird collision treatment, which has been applied to glass 10, consists of a plurality of markings 16 which are placed some distance from each other. To maximize visibility to birds, markings 16 are dark and take the form of the silhouette of a predatory bird. Markings 16 are separated from each other by distance 20 which will usually be several feet. Due to their large size and dark colour, markings 16 would likely be visible to birds. Large spaces 18 are formed between markings 16 which have the appearance of empty space. Therefore, despite the fact that several markings are placed on the window, bird collisions will still occur because birds will be confused into thinking that they can fly freely between the markings. The large and numerous markings 16 also tend to be highly visible from the inside of the building to which window pane 12 is attached. Therefore, this prior art anti-bird collision treatment is both obtrusive and ineffective because it greatly obstructs the view out the glass while still allowing for possible bird collisions. The present invention, by contrast, provides a window treatment which is quite subtle but at the same time highly effective in preventing bird collisions.

An anti-bird collision glass treatment made in accordance with the present invention is shown generally in FIG. 2 and consists of a plurality of visible markings 22 formed on the outside surface 28 of glass panel 24. The exterior glass panel is of course contained within frame 26. Visible markings 22 are separated from each other by a horizontal distance 30 not exceeding 4.5 inches and by a vertical distance 32 not exceeding 2.5 inches. Markings 22 are each a few mm in diameter preferably between 2 to 6 mm, although they may be larger, provided the vertical and horizontal distances separating the markings do not exceed 2.5 inches and 4.5 inches, respectively. The total surface area taken up by markings 22 should be no greater than 15% of the surface area of outside surface 28 so that the marking will not appear obtrusive to viewers inside the building. The visibility of the glass after treatment is very high, with optically clear space between the markings at or exceeding 85% to provide acceptable visibility.

Markings 22 can take the form of circles, squares, triangles or any other shape and may even consist of small clusters of markings or lines. Markings 22 are formed on the outside surface 28 of the glass panel 24 to ensure that the markings remain visible to birds. It has been discovered that placing the markings on the outside surface of the glass is much more effective in preventing bird collisions than placing the markings on the inside surface of the glass. If the markings are placed on the inside surface of the glass (i.e. any surface other than the exterior), then the markings will be less visible to flying birds because the exterior surface of glass is highly reflective, especially if glass is tinted or incorporates a reflective coating on any other surfaces.

Markings 22 can take the form of adhesive backed vinyl markings, which are transferred from a backing material to the exterior glass surface. Alternatively, markings 22 could take the form of ceramic fits formed on the glass or even etchings. Markings 22 may also be formed on a separate flexible plastic laminate on which the markings are printed and is layered onto the exterior surface of the glass. It is also possible to form markings 22 as plastic stickers or sheets which reflect ultraviolet light, but which are substantially transparent to light in the visible spectrum. Such ultraviolet light reflecting markings would be visible to flying birds (provided the markings are positioned on the exterior surface of the glass) but would be almost invisible to people inside the building looking out of the glass.

The markings may be of any shape or size, with a typical diameter of between 2 and 6 mm. To be effective, the markings must be placed on the outside surface of the glass, the horizontal space separating the markings does not exceed 4.5 inches and the vertical space separating the markings does not exceed 2.5 inches. FIG. 6 illustrated four different arrangements of markings which would be effective in preventing bird collisions provided the correct vertical and horizontal separation is maintained. The markings could take the form of small individual markings 58 or as clusters 52 of smaller markings. Clusters 52 are separated from each other by a horizontal distance 54 of no greater than 4.5 inches and by a vertical distance 56 of no greater than 2.5 inches. Alternatively, it is possible to produce an effective s treatment with markings arranged as vertical or horizontal lines. Vertical lines 60 are separated from each other by a horizontal distance 62 of no greater than 4.5 inches while horizontal lines 62 are separated by a vertical distance 64 of no greater than 2.5 inches. It is possible to form the markings on a flexible transparent film 66 by means of printing, with the film being adhered to the surface of glass 51 by means of an adhesive. Film 66 may be smaller than window 50 and tiled in order to cover the entire surface, but preferably film 66 would be sufficiently large to cover the entire window in one piece.

It has been discovered that increasing either the horizontal or vertical separation between the markings beyond the 4.5 and 2.5 inch ranges, respectively, significantly decreases the effectiveness of the glass treatment in avoid bird collisions. Decreasing one or both of these dimensions will have the effect of increasing the surface area occupied by markings 22 thereby increasing the obtrusiveness of the glass treatment. The goal is to provide a glass treatment which is as unobtrusive as possible. To achieve this goal, the total surface area occupied by markings 22 should be no greater than 15%. Spacing the markings at a horizontal separation of 4.5 inches and vertical separation of 2.5 inches decreases the overall obtrusiveness of the glass treatment by bringing percentage of surface area occupied by markings to well below 15%. If each marking is no more than 5 mm in diameter, the overall glass treatment is both highly effective against bird collisions but is also very subtle and not obtrusive.

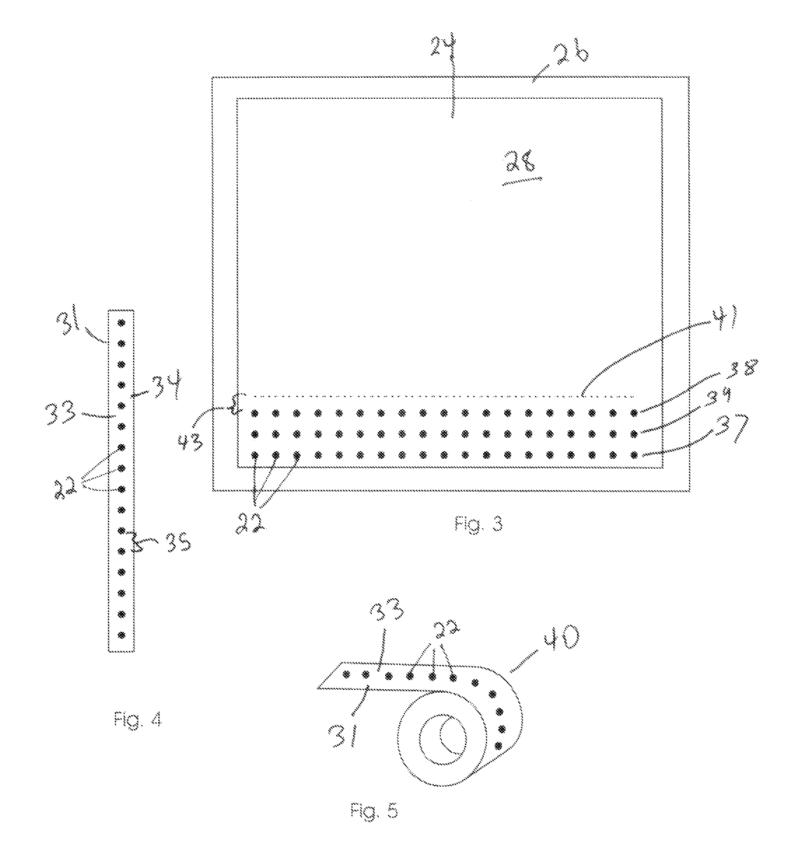

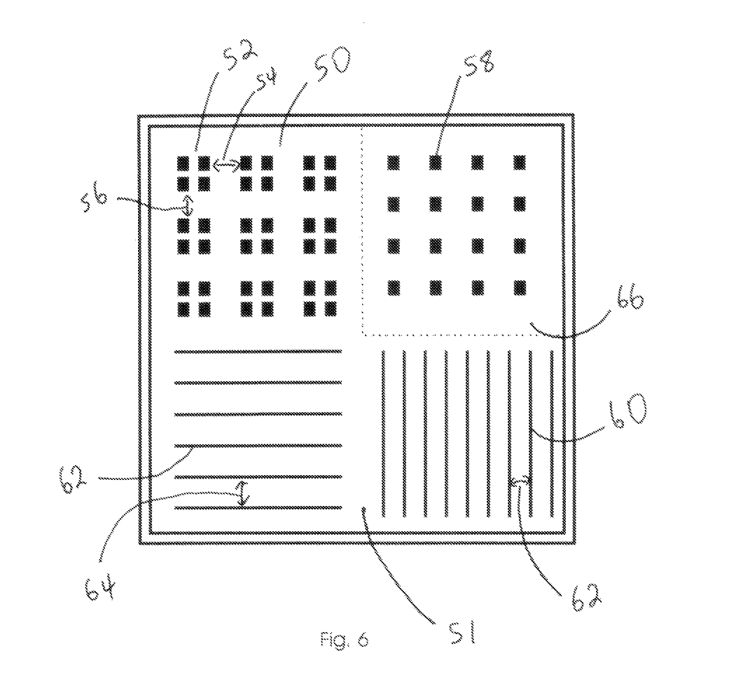

Referring now to FIGS. 3, 4 and 5, preferably markings 22 consist of plastic stickers which are adhered loosely onto a long flexible strip of backing material. The backing material makes it easy to apply the stickers to surface 28 of exterior glass pane 24. As shown in FIG. 5, roll 40 consists of a large roll incorporating both the markings (stickers) and flexible backing material. Markings can take the form of an adhesive backed opaque or translucent vinyl, which are transferred from the backing material to the exterior glass surface. Flexible backing sheet 31 is made of any suitable flexible material such as waxed paper or the like and has surface 33 upon which stickers 22 (markings) are loosely adhered. Stickers 22 are preferably positioned on sheet 31 as one long single row with the stickers equally spaced from each other and separated by a distance 35. Stickers have one side in contact with surface 33 and an opposite side upon which a strong adhesive has been applied to permit the stickers to adhere tightly to surface 28. Portion 34 is cut from sheet 31 and has a length equal to the width or height of the glass pane 24 depending on whether a horizontal or vertical pattern for applying the stickers is desired. To apply the glass treatment to exterior glass pane 24, the width or height of glass pane 24 is first measured and then a plurality of equal length strips 34 are measured and cut from roll 40. Strips 34 are then placed on surface 28, one at a time, such that the markings are 2.5 inches or less apart if installed horizontally or 4.5 inches or less apart if installed vertically.

Markings 22 are formed on strip 31 such that when strips 34 are cut and placed onto glass pane 24 as described above, the markings will be separated horizontally by a distance not exceeding 4.5 inches and vertically not exceeding 2.5 inches. For the purposes of this discussion, let us assume that the markings 22 are going to be applied horizontally. A first line of stickers (markings) 37 is first laid down by applying portion 34 to the glass plane and pressing surface 33 against surface 28 with sufficient force to cause stickers 22 to adhere to the surface of the glass. When the stickers are thus adhered to the surface of the glass, portion 34 is then removed from the surface leaving behind a line 37 of markings 22. A next portion 34 is then laid down adjacent to and parallel with line 37 and pressed against the glass to lay down a line 39 of markings 22. The steps are repeated to lay down the next line of stickers 38. A distance of 43 is measured between the laying down of the next line of stickers (41) and the last row of stickers. In the present example, distance 35 is pre-selected to be no greater than 2.5 inches since stickers 22 are to be applied to glass 24 in a horizontal fashion. If the markings are to be applied using this method in a vertical fashion (i.e. with strips of flexible material being laid down in a vertical orientation), then the stickers would be separated on the flexible strip by a distance of no greater than 2.5 inches and markings on one strip separated from markings on adjacent strips by no greater than 4.5 inches. While the strip 31 could be cut into square sheets, it is anticipated that long strips would be easier and quicker to install and provide much less wastage.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A glass treatment for treating exterior glass to prevent bird collisions with the glass, the treatment comprising a plurality of visible markings applied to an exterior surface of the glass, the plurality of markings extending substantially across the entire exterior surface, the markings being separated from each other by a vertical distance not exceeding 2.5 inches and by a horizontal distance not exceeding 4.5 inches, the markings occupying no more than 15% of the exterior surface of the glass.

2. The glass treatment defined in claim 1 wherein the markings each form polygon dots.

3. The glass treatment defined in claim 1 wherein each of the markings comprises a small sticker adhered to the surface of the glass.

4. The glass treatment defined in claim 3 wherein the stickers reflect UV light but are substantially transparent to visible light.

5. The glass treatment defined in claim 1 wherein the markings are separated from each other by a vertical distance of about 2.5 inches and by a horizontal distance of about 4.5 inches.

6. A glass treatment defined in claim 1 wherein each of the markings comprises a cluster of smaller markings, the clusters of smaller markings being separated from each other by a horizontal distance of no greater than 4.5 inches and by a vertical distance of no greater than 2.5 inches.

7. The glass treatment defined in claim 1 wherein the markings contrast in appearance to the exterior surface of the glass.

8. The glass treatment of claim 1 wherein the markings are formed on a flexible film which is applied to the exterior surface of the glass.

9. The glass treatment of claim 2 wherein the dots each have a diameter of between 2 to 6 mm.

10. A method of applying the glass treatment defined in claim 1 comprising the steps of:
a. Providing an elongated flexible strip having a row of equally spaced stickers formed on a first side thereof, the stickers each having a first side loosely adhered to the first side of the flexible strip and a second side having an adhesive configured to securely adhere the sticker to the exterior surface of the glass;
b. The row of stickers on the flexible strip each being separated by a first distance;
c. A first portion of the flexible strip being laid across the exterior surface of the glass in a first line, the first side of said first portion of flexible strip being pressed against the exterior surface of the glass as the first line is laid with sufficient force to cause the stickers on the first portion of the flexible strip to adhere to the glass;
d. The first portion of the flexible strip then being removed from the surface of the glass to leave a first line of markings adhered to the exterior surface of the glass;
e. A second portion of the flexible strip then being laid across the exterior surface of the glass in a second line adjacent to and parallel with the first line of markings, the second line being spaced from the first line by a second distance, the first side of said second portion of flexible strip being pressed against the exterior surface of the glass with sufficient force to cause the stickers on the second portion of the flexible strip to adhere to the glass;
f. The second portion of the flexible strip then being removed from the surface of the glass to leave a second line of markings adhered to the exterior surface of the glass;
g. Steps d to f being repeated until substantially the entire external surface of the glass is covered;
h. The first and second distances being selected such that the markings which are placed on the exterior surface of the glass are separated by the vertical distance of no more than 2.5 inches and by the horizontal distance of no more than 4.5 inches.
